(19) United States
(12) Patent Application Publication
(10) Pub. No.: US 2024/0265481 A1
(43) Pub. Date: Aug. 8, 2024

(54) SYSTEM AND METHOD FOR GENERATING CONTENT BASED ON OTHER SOURCE CONTENT

(71) Applicant: LearnExperts EdTech Inc., Ottawa (CA)

(72) Inventors: Marcelo BURSZTEIN, Ottawa (CA); Sarah SEDGMAN, Ottawa (CA); Leah MCGUIRE, Carleton Place (CA); Taunya MACDONALD, North Gower (CA); David DEWAR, Manotick (CA)

(21) Appl. No.: 18/288,527

(22) PCT Filed: Apr. 27, 2022
(86) PCT No.: PCT/CA2022/050638

§ 371 Date: Oct. 26, 2023

Related U.S. Application Data
(60) Provisional application No. 63/180,453, filed on Apr. 27, 2021.

(51) Int. Cl. G06Q 50/20; G06Q 30/0241

(52) U.S. Cl. CPC G06Q 50/20; G06Q 30/0241

(57) ABSTRACT

System and method for generating content suitable for specific uses in specific fields, such as for instructional documents, based on other input sources. Content is extracted from at least one input source by an extraction module. An analyzer module determines whether the content meets at least one standard used in the field for the specific use. If the standard(s) is not met, a transformation module transforms the content to meet the standard. In some embodiments, a user can edit and/or approve the content. The system detects further violations of the standard(s) while the user edits the content and displays a recommended transformation. When the user approves of the content, a content package comprising all, or part of, the content is generated. In some embodiments, the approved output content is stored for reuse in other content packages/projects and/or by other users.

### TECHNICAL FIELD

The present invention relates to content generation. More specifically, the present invention relates to generating content suitable for specific uses in specific fields based on other input source content.

### BACKGROUND

Training and instruction is a necessity for every organization, both to improve specific skills and to provide more generalized knowledge. Many organizations already have significant resources and reference materials (such as, e.g., software documentation) that provide valuable information about topics for which training may be desired. However, these resources are typically in inconvenient formats and/or spread across many different documents, making effective and efficient training difficult. Further, the content of these resources is rarely aligned with standards or best practices for educational/instructional materials, again making them inconvenient for training purposes.

Further, the generation of instructional content remains a manual, time-consuming, and labour-intensive process. People must either look for content or data that already exists in the form of documents (e.g., text, diagrams, or other content), or must interview a subject matter expert in person. They must then structure the content into a coherent whole and, as necessary, manually transform the content to align with best practices for instructional documents.

The tools used to do this process today are common tools/technology such as PowerPoint™, Word™, Google Docs™, PDF manipulation software, and so forth. The individual editing the content must manually transfer the content between different applications (in some cases, using custom macros or printed guides). This process can be extremely inefficient: for example, it may require 250 hours of development time for a skilled instructional designer to develop 1 hour of training material (which may cost thousands of dollars). Given the amount of training material needed on an everyday basis, organizations often rely on non-experts to generate such material, reducing the quality of the materials produced.

Although many e-learning tools and systems are available, these generally relate to the delivery, rather than the generation, of content. Tools related to the production of content may add small efficiencies to some aspects of the process, but do not provide an end-to-end system for generating instructional content. Instead, they generally add extra steps for the user, rather than reducing work for the user.

Similarly, generating content for other types of documents, such as marketing and/or legal documents, is also still a primarily manual, tedious, and expensive process. Accordingly, numerous organizations would benefit from systems that aggregate and transform content to produce new content suitable for specific uses in specific fields.

Given the above, there is clearly a need for systems and methods that overcome the disadvantages of the prior art.

### SUMMARY

This document discloses a system and method for generating content suitable for specific uses in specific fields, such as for instructional documents, based on other input sources. Content is extracted from at least one input source by an extraction module. An analyzer module determines whether the content meets at least one standard used in the field for the specific use. If the standard(s) is not met, a transformation module transforms the content to meet the standard. In some embodiments, a user can edit and/or approve the content. The system detects further violations of the standard(s) while the user edits the content and displays a recommended transformation. When the user approves of the content, a content package comprising all, or part of, the content is generated. In some embodiments, the approved output content is stored for reuse in other content packages/projects and/or by other users.

In a first aspect, this document discloses a system for generating output content based on other input sources, said output content being suitable for a specific use in a specific field, the system comprising: a server comprising: an extraction module for extracting content from an input source: an analyzer module for determining whether said content meets at least one standard used in said specific field; and a transformation module for transforming said content to thereby produce new content when said content does not meet said at least one standard, said new content meeting said at least one standard.

In another embodiment, this document discloses a system further comprising an editor interface in communication with said server, wherein said editor interface is usable by a user to edit said new content to thereby produce edited content, said edited content being used to produce said output content.

In another embodiment, this document discloses a system wherein, responsive to instructions from said user, said editor interface generates a content package containing said output content, said content package thereby being useful in said specific field.

In another embodiment, this document discloses a system wherein said editor interface communicates with said analyzer module to iteratively determine whether user content meets said at least one standard, said user content being added in said editor interface by said user

In another embodiment, this document discloses a system wherein said editor interface further communicates with said transformation module to generate a recommended transformation

In another embodiment, this document discloses a system wherein, when said user content does not meet said at least one standard, said editor interface displays an alert to said user.

In another embodiment, this document discloses a system wherein, when said user content does not meet said at least one standard, said editor interface displays an alert to said user, and wherein said alert comprises said recommended transformation.

In another embodiment, this document discloses a system wherein said content is text content and said at least one standard relates to at least one of a format used in said field, a language style used in said field, and a grammatical principle.

In another embodiment, this document discloses a system wherein said extraction module is further for pre-processing said content.

In another embodiment, this document discloses wherein said specific use is at least one of: instructional, educational, legal, promotional, marketing-related, related to a commercial purpose, and related to a non-commercial purpose.

In another embodiment, this document discloses wherein said input source comprises a plurality of input sources, and wherein the transformation module aggregates content from said plurality of input sources, such that said content package generated by said system comprises output content based on said plurality of input sources.

In a second aspect, this document discloses a method for generating output content based on other input sources, said output content being suitable for a specific use in a specific field, said method comprising the steps of:
receiving an input source:
extracting content from said input source:
determining whether said content meets at least one standard used in said specific field;
when said content does not meet said at least one standard, transforming said content to thereby produce new content, said new content meeting said at least one standard; and
generating a content package comprising said new content.

In another embodiment, this document discloses a method further comprising displaying said new content to a user to thereby permit said user to approve said new content before said content package is generated.

In another embodiment, this document discloses a method wherein said user edits said new content before said content package is generated.

In another embodiment, this document discloses a method further comprising displaying an alert to said user when said content does not meet said at least one standard.

In another embodiment, this document discloses a method wherein said alert comprises a recommended transformation for said content.

In another embodiment, this document discloses a method wherein said alert comprises a current score for said content, said score representing a number of violations of standards currently found in said content.

In another embodiment, this document discloses a method wherein scores for multiple pieces of content are presented to at least one user.

In another embodiment, this document discloses a method wherein said user approves said recommended transformation and wherein said transformation is executed based on said approval by said user.

In another embodiment, this document discloses a method wherein said content is text content and said at least one standard relates to at least one of a format used in said field, a language style used in said field, and a grammatical principle.

In another embodiment, this document discloses a method further comprising a step of pre-processing said content.

In another embodiment, this document discloses a method wherein said specific use is at least one of: instructional, educational, legal, promotional, marketing-related, related to a commercial purpose, and related to a non-commercial purpose.

### BRIEF DESCRIPTION OF THE DRAWINGS

The present invention will now be described by reference to the following figures, in which identical reference numerals refer to identical elements and in which:

FIG. 1A is a block diagram of a system according to one aspect of the invention;

FIG. 1B is a block diagram of a system according to another embodiment of the invention;

FIG. 2 is a schematic diagram for an exemplary implementation of a system according to an aspect of the invention;

FIG. 3 is a screenshot of an exemplary editor interface for use with the implementation of FIG. 2;

FIG. 4 is a flowchart detailing a method according to one aspect of the invention; and

FIG. 5 is a flowchart detailing a method according to another aspect of the invention.

### DETAILED DESCRIPTION

The present invention provides a system and method for generating documents based on other documents according to best practices and standards for specific uses in specific fields. For instance, the present invention is suitable for generating instructional content that meet standards used for instructional content, based on one or more input sources that are not necessarily instructional in nature. Content is extracted from the input source(s) and analyzed based on best practices/standards used in the specific field for the specific use (e.g., instructional use, marketing use, etc.). When the content does not meet those standards, the content is transformed so that the standards are met. The content is then displayed to a user who can edit the content. In one embodiment, the user edits the content via an editor interface. In another embodiment, the user edits the content via a third-party application or system that accesses the system of the present invention and uses the system to analyze the edited content. While the user edits the content, and/or between editing sessions, the system iteratively analyzes the edited content and recommends transformations based on the best practices. Once the user approves the content, the content can be exported as a ‘content package’ comprising one or more output documents/files of any suitable format.

As would be clear to the person skilled in the art, the term ‘content’ as used herein refers to any and all content types or formats (including, without limitation, text content/data, audio or video content, numerical data, image content/data, and other unidimensional or multi-dimensional data). Similarly, the terms ‘input source’ is intended to mean and should be construed as meaning files in any and all suitable formats (including, without limitation, text documents, image files, audio and/video files, and other data files). Further, the term ‘content package’ should be construed as being one or more files/documents, of any suitable format, that comprises all or a portion of the content generated by the system.

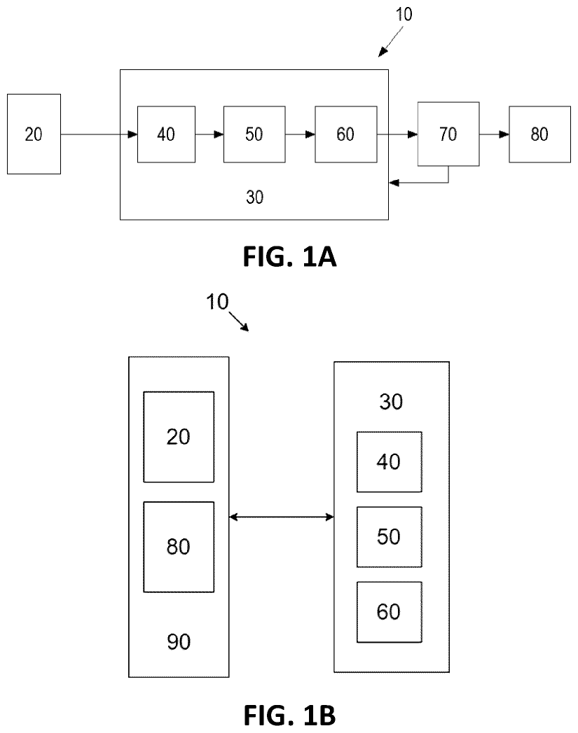

FIG. 1A is a block diagram of a system 10 according to one aspect of the invention. Input source 20 is passed to a server 30 which hosts a content extraction module 40. The content extraction module 40 extracts the content, which is then analyzed by the analyzer module 50. The analyzer module 50 determines whether the content meets one or more standards. The content and the results of the analysis are then passed to a transformation module 60. Based on the results of the analysis, the transformation module 60 transforms the content to meet the applicable standard(s). In this embodiment, the transformed content is then edited and/or reviewed by a user, using the editor interface 70. As the user edits the content, the new content is iteratively analyzed by the analyzer module 50 and recommended transformations are suggested to the user. When the user is satisfied with the content, a document comprising the content (or a portion of the content)—i.e., a content package 80—can be generated for the user.

FIG. 1B is another block diagram of a system that is similar to that shown in FIG. 1A. However, in the embodiment of FIG. 1B, no editor interface 70 is used. Rather, the input source 20 is hosted by a separate third-party system or application 90 used by the user, which has access to the server 30. The various modules hosted on the server 30 (i.e., the content extraction module 40, the analyzer module 50, and the transformation module 60) are called by the third-party system or application 90. As a non-limiting example, the system or application 90 may be a system run on a user's desktop or through a browser interface that accesses one or more of the various modules 40, 50, and 60 using one or more Application Programming Interfaces (APIs) or other integrations. In such an embodiment, the user could use the functionality of the modules 40, 50, 60 without being required to install, access, or use an unknown interface program. Additionally, in such an implementation, the input source is directly modified, on the third-party system or application, to thereby produce the content package.

### Content Extraction

Content extraction module 40 may extract the content from input source 20 using any suitable technique. In some embodiments, depending on the format of the input source(s), the content may be readily obtainable. That is, the content may be directly extracted from the input source 20 using, e.g., an API. In other embodiments or with input sources of different formats, extraction of content in a suitable form may be more difficult. In some embodiments, optical character recognition (OCR) processes may be necessary to extract the content. Further, in some embodiments, machine learning processes and techniques such as natural language processing (NLP) may be necessary to extract the content. In one implementation of the invention, content may be extracted from documents formatted as .DOC, DOCX, .PPTX, and .PDF document types. However, as mentioned above, any suitably formatted input source may be used, including, without limitation, input sources in audio formats, video formats, etc.

Further, in some embodiments, the input source comprises a plurality of sources. That is, in a preferred embodiment, a user could upload multiple pre-existing, unconnected input sources that relate to a single topic and generate a new content package based on aggregated content from all such sources.

In a preferred embodiment, the content is extracted as HTML (hypertext markup language) or similar semantically-marked up or structured content, such that the original formatting is preserved. Further, at least part of the content preferably comprises text content. Other forms of content, such as audio or video files, may be extracted, in some embodiments. However, as would be clear to the person skilled in the art, the system in some embodiments might be directed to analyze and transform only text content and to preserve non-text content in its original form. Further, in some embodiments, the system may generate placeholder text for non-text content, which may later be edited by the user.

In some embodiments, the system also stores content on an ongoing basis as input sources are provided to the system. That is, extracted content is retained (i.e., in an associated database) and classified according to topic. The retained content can then be used to generate other output content of the same type that are related to the same topic. For clarity, this retained content may be used by other users and/or for other projects. The system can thus become more efficient as it is used further. Of course, individual users may prefer not to allow the content they upload to be reused. Alternatively, the user may prefer to be the only user allowed to reuse that content, or only for users within their organization to reuse that content. Privacy settings may be set accordingly.

### Analysis

The analyzer module 50 may use any combination of rules/logic to analyze the content against the predetermined standard(s). Additionally, machine learning techniques such as natural language processing (NLP) may also be used. For example, the analyzer module 50 may use NLP to identify the parts of speech comprising a given content element (e.g., noun, verb, etc.). The analyzer module 50 may then use NLP to identify whether the content element meets the applicable standard(s). For example, in an instructional document, headings preferably begin with a verb (specifically, a gerund). NLP can be used to identify the first word in a heading and to determine whether that word is a gerund (i.e., meets the standard) or not a gerund (i.e., does not meet the standard). The analyzer module 50 can also use non-machine learning processes to analyze the content, for instance to determine whether the length of a given piece of content is longer or shorter than a standard length (or length range).

The standards may relate to document format (e.g., heading location, paragraph structure and/or length), as well as to characteristics that are inherent in the content. For text content, such characteristics may include grammatical principles (e.g., subject-verb agreement) and language style considerations (e.g., passive vs. active voice). Of course, depending on the intended use of the output content, standards may vary. For instance, for instructional documents in English, reducing the use of the passive voice is often preferable. However, for scientific reports in English, increasing the use of the passive voice may be preferable.

Further, different fields and topics may have different standards. As one example, the ‘text comprehension difficulty’ considered acceptable for a marketing document for use with consumer software may be different than for a marketing document for use in the financial industry. The present invention may be configured to transform the content based on any such standard. Without limitation, some exemplary types of content that may be generated by the system herein disclosed are instructional content, educational content, legal content, promotional content, and marketing-related content. Additionally, generated content may be suitable for uses related to commercial purposes and uses related to non-commercial purposes. Other types of content, as would be understood, may also be generated by the systems disclosed herein.

Additionally, content in any language may be transformed by this invention. As would be clear to the person of skill in the art, each language may have different standards for different types of content. For instance, some languages may require more formality in a certain type of content than other languages require in the same type of content. Further, in some implementations, content sources in multiple languages can be input to the system. The system 10 can extract that content and identify the source language and further translate the content into a language of a desired output. In some embodiments, the system 10 accesses third-party translation systems to generate the translated content. Standards applicable for the language of the desired output could then be used to analyze and transform the content to produce the output content or content package. As well, depending on the embodiment, translation may occur before or after analysis and transformations. For example, English-language content may be analyzed and transformed in line with best practices, and then translated into French. However, as the standards that apply to English and French may be different, the generated translation may be further analyzed based on French standards. In other embodiments, unanalyzed English-language content is directly translated into French and then analyzed according to French standards.

### Detection Violations and Document Context

In some embodiments, the detections (i.e., identified violations of best practices) are gathered with an associated ‘document context’ parameter. This ‘document context’ parameter provides an indication of the location of the detection within the document. For example, the document context parameter is, in some embodiments, a metadata link between a record of a detection and an object within the document (e.g. a paragraph, a list item, a cell in a table, an image, etc.). As would be understood, the exact format of such a link or parameter depends on the specific detection, document format, and/or object at which the detection is made. The parameter can comprise (without limitation):
violation id: a hash value that indicates whether the specific violation has already been detected and/or reviewed;
the type of detection violation (depending on the input source);
a path to a top-level element (e.g., the beginning of a list);
a sub-path if the element is nested within other elements (e.g., a lower list element). The sub-path may be stored as an array indicating the location of the detection (e.g., [0] or [1,0] or [1,0,0,1], etc.), where each field in the array is associated with a specific location in the document;
the element node type (again, depending on the format of the input source, e.g., when the input source is structured as a hierarchy of nodes);
text which can be used to identify the location of the detection (to find, visually highlight or as a location for transformations). This text can be stored as a string of words or as an array of words (to assist with fuzzy matching after editing by the user);
an indication of a review state of the detection;
a type of recommended transformation; and/or
an indication of a specific recommended or performed transformation.

Such a parameter allows the detections to be ordered and used to navigate to different parts of the document where the violations occur. The context parameter also allows detection locations to be readily located when the transformation module 60 determines where to apply transformations into the content of the document. That is, rather than redetecting violations every time the transformation module 60 is called, storing records of the detection associated with a context parameter allows the transformation module 60 to simply locate the detection and apply a transformation.

As would be understood, different levels of document context parameters are available, depending on the implementation and the source content. Some non-limiting examples include:
‘Document Level’ detections (e.g., the entire document is scanned for certain features, such as document length, overall reading level required, etc.):
‘Block Level’ detections related to the large elements of the document (e.g., a paragraph, a list item, a cell in a table, an image, etc.):
‘Sentence Level’ detections (e.g., sentence structure or grammar); and
‘Text Level’ detections (e.g., word choice, typographical issues).

As well, in some embodiments, the document context parameter comprises a loose association with the violation, such that the detection can be ordered and located even if the user has edited the violation and the detections have not yet been recomputed.

The document context parameter can also be used to speed up the detection analysis and transformer steps. When a document is edited, the previous edit version is compared to the current edit version, to thereby produce a list of the precise changes that have been made to the content and where these changes have occurred. In some embodiments, the entire edited document is compared to the previous edit version, while, in other embodiments, only sections of the document that were previously edited are compared to corresponding sections of the previous edit version. As well, in some embodiments, the edited documents are compared on an ongoing basis (i.e., in real-time while a user edits). In other embodiments, the documents are compared after an editing session is completed—i.e., when a user saves a new edited version of the document. The list of changes is then stored by the server 30. The list is then used by the analyzer module 50 to target its next analysis/detection. This improves performance of the system, as the analyzer module 50 thus only needs to analyze the parts of the document (identified in the list) that have actually changed. This reduces necessary processing and allows quick updates in the editor interface 70 or the third-party system or application 90 while the content is being edited.

Additionally, storing document context parameters allows violation detections that are no longer relevant to be automatically removed (by indicating that the violating content has been removed from the document.

### Transformations

The transformation module 60 uses any appropriate combination of ML and rules/logic-based processes to transform the content according to the standard(s). For instance, if the standard relates to word length and a given content element is too long, a rule may require that “filler words” such as articles be deleted. As another example, header words such as “overview” may be replaced with the term “introducing” and the sentence rearranged. Of course, NLP may be used to identify words similar to “overview” (including, without limitation, misspellings thereof) that should be replaced.

In some embodiments, the detections (i.e., identified violations) are also stored and/or cached by the system, either on the server 30, a device used by the user to access the editor interface 70, or a device supporting the third-party system or application 90, depending on the embodiment. In such embodiments, the detections are fetched from the storage location/cache when a detection with an identical input has been previously computed, which can reduce/improve the processing time of a specific content element.

### Editing

As described above, in some embodiments, the system comprises an editor interface 70. In other embodiments, an editor interface may comprise a third-party system or application, such as Microsoft Word™ or other word processing software or other editing or design applications. Additionally, in some embodiments, an editor may be in continuous communication with the server 30. However, in other embodiments, the editor and the server 30 are not in continuous communication with each other. In such embodiments, the user receives the new content from the server 30, edits that new content in an editor that is external to the system 10, and passes the edited content back to the server 30 for reanalysis.

In interfaces where an editor interface 70 is provided, or where the modules 40, 50, 60 are integrated with an existing external editor (e.g., through APIs), the editor interface 70 preferably provides a text editor window to the user. The user can preferably edit any part of the content or change the format of any content. If such changes result in violations of the applicable best practices/standards, however, the editor interface 70 alerts the user of such a violation (e.g., via a new ‘detection card’ such as a pop-up or alert notification displayed on the interface screen). In one embodiment, further, the alert may comprise a recommended transformation that can be adopted by the user. Such a recommended transformation is a suggestion of content that would not violate the applicable best practices/standards. Preferably, if the user selects the recommended transformation, the content is automatically transformed. However, in some embodiments, the user may be required to manually replace the violating content with the recommended transformation. Preferably, in embodiments using a third-party system or application 90 to access the server 30, the integration/API provides for such notifications to be displayed to the user within the third-party system or application 90.

The editor interface 70 may enable any suitable edits by the user using any suitable techniques, including, without limitation, direct text entry using a keyboard, drag-and-drop replacement, embedding of image files and/or audio/video files (remote or locally hosted) and/or interactive elements, voice-to-text entry, and so forth.

Additionally, in some embodiments, the editor interface 70 may be hosted on the server 30 (i.e., as an online interface) or be an application running on a user's device. In some embodiments, the interface 70 may have both server-hosted and device-hosted capabilities. As would be readily understood, different embodiments may provide different advantages with respect to processing power, time, and/or security.

In some embodiments, the analyzer module 50 analyzes the content while the user is editing the content, while, in other embodiments, the content is analyzed after an editing session. Of course, in some embodiments, the user may be able to choose between real-time analysis and non-real-time analysis.

The output content package 80 may comprise all of the extracted/transformed content or simply a portion or portions thereof. Additionally, the output content package 80 may comprise a summary of the approved output content. For instance, in an embodiment where the standards used are standards for instructional documents, the output content package 80 can be the instructional document itself or an associated lesson plan or other summary document. The editor interface 70 preferably allows the user to select which assets should be generated as output content package 80. Summaries and other related documents are preferably generated from the approved output content using NLP, but may be generated by purely rules-based processes in other embodiments of the invention. (For example, in some embodiments, a ‘course summary’ is generated simply by extracting an introductory paragraph of the course document.) Other assets, such as assessment tools, may also be generated by the system 10.

Further, in some embodiments, the editor interface 70 provides metrics for the generated content, such as, e.g., ‘read-through time’ and ‘reading difficulty’. Such metrics are preferably iteratively generated during the user's edits and may be used to direct or guide further refinements of the content. For instance, if the instructional content are assessed as having a ‘university-level’ reading difficulty according to known metrics, and the user intends to provide the content for everyday use, such a metric may prompt the user to reduce the reading difficulty. Alternatively, or additionally, of course, such considerations may be part of the standards automatically analyzed by the system. In some embodiments, further, the user can choose between different sets of best practices/standards. For example, when initially uploading an input source 20, the user may indicate that they wish an output content package at a grade-five reading level, or a grade-nine reading level, or any similar consideration. That is, a user may be able to select different standards and/or sets of standards to apply to a given input source without changing applications.

### Gamification

In some embodiments, the system 10 can score content and give a user a target score to try to achieve, displayed through the editor interface 70 or the third-party system or application 90. The violations represent areas for improvement for content creators. The system can show:
an overall score which represents the quality of the content (wherein zero violations represents a perfect score):
visual and text encouragement to content creators to encourage them to deal with all content violations; and/or
a congratulations message when all violations have been addressed.

Scores can be accumulated across content documents to thereby produce a leaderboard or other ranking for content creators across an organization. That is, in some embodiments, scores for multiple pieces of content are displayed to at least one user. A user may have the option of comparing scores between their own pieces of content and/or pieces of content produced and/or edited by other users. The scores can motivate users to improve the quality of their content.

### Currency of Information

In embodiments of the system that store content, as described above, the system 10 can also analyze the content based on its currency. For instance, where the system 10 has substantial recent content related to a given topic, newly added content can be analyzed to consider whether that newly added content is up to date. As an example, if a user provided a coding manual for the Python computer language from 2010 as an input source, the system could preferably review that content against more recent content related to the Python computer language and use updated content as necessary. The more recent content can be retrieved from third-party systems or from material previously stored in the system 10.

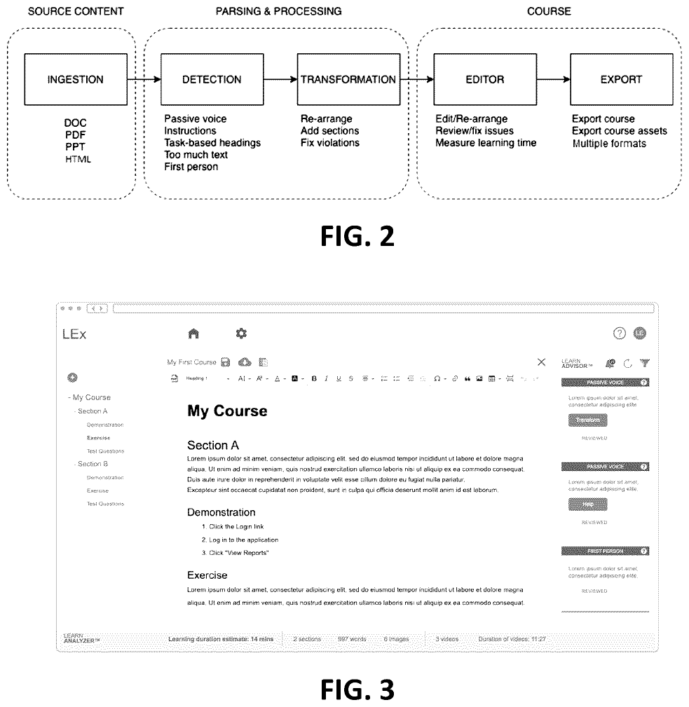

Referring now to FIG. 2, a schematic process diagram for an exemplary implementation of the invention is shown. This exemplary implementation is for English-language instructional documents. Accordingly, the standards reflect best practices of such documents.

FIG. 3 is a screenshot of an editor interface 70 for use with the exemplary implementation of FIG. 2. This exemplary interface provides various features as described above. Again, the person skilled in the art would understand that all such features are for use with English-language instructional documents and that, for output content of a different use, field/topic, and/or language, different specific features and standards may apply.

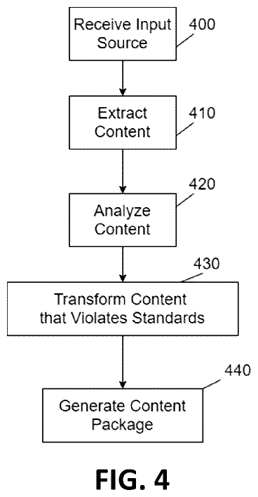

FIG. 4 is a flowchart detailing a method according to one aspect of the invention. At step 400, an input source is received. As noted above, the input source(s) may have various formats and/or content. At step 410, the content of the input source is extracted. The extracted content is then analyzed against standards used in the specific field of the desired output content at step 420. Content that violates (i.e., does not meet) those standards is transformed at step 430. The transformed content is then output to a new content package at step 440.

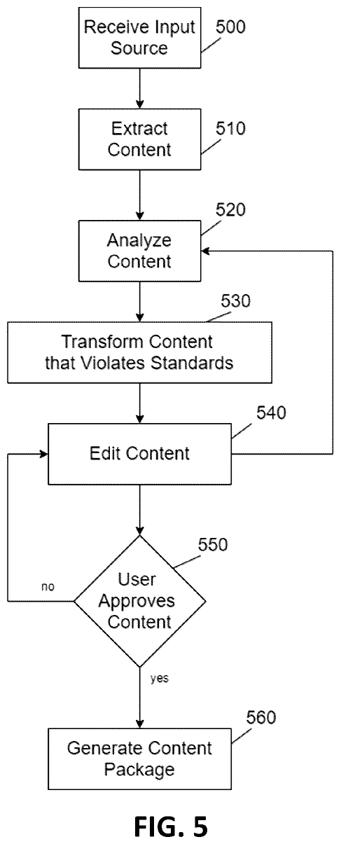

FIG. 5 is another flowchart detailing another method according to embodiments of the invention. Steps 500 to 530 are comparable to steps 400 to 430 described above with respect to FIG. 4. However, at step 540, the transformed content is displayed to a user via an editor interface. The user may edit the content through this editor interface as desired. Further, as described above, the editor interface and the system iteratively analyze the edited content and may recommend and/or perform further transformations while the user's edits are in progress. When the user approves of the content at step 550, an output content package may be generated at step 560.

As would be clear, various modules and methods of the invention may be implemented in different ways. For instance, in some embodiments of the system, the content may be extracted from the input source 20 before being passed to the server 30. Such an embodiment may provide desirable efficiencies. Similarly, in some embodiments, a single module may perform the functions of the analyzer module 50 and the transformation module 60. Further, as would be clear, in preferable implementations, the analyzer module 50 and the transformation module 60 are integrated with the editor interface 70 such that the distinctions between the modules are not apparent to the end user. Additionally, in some implementations, the functions of each of the analyzer module 50, the transformation module 60, and the editor interface 70 are performed by a single module. It should be clear that any and all such well-understood alterations are intended to fall within the scope of this invention.

As well, the server 30 should be understood as encompassing a locally hosted server in a single location, a remotely hosted server in a single location, and a plurality of distributed/remote servers in one or more locations, as suitable for the given implementation.

Further, it should be clear that the various aspects of the present invention may be implemented as software modules in an overall software system. As such, the present invention may thus take the form of computer executable instructions that, when executed, implements various software modules with predefined functions.

Further details of exemplary implementations of the invention may be found by reviewing the attached appendix.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for generating output content based on other input sources, said output content being suitable for a specific use in a specific field, the system comprising:
a server comprising:
an extraction module for extracting content from an input source;
an analyzer module for determining whether said content meets at least one standard used in said specific field; and
a transformation module for transforming said content to thereby produce new content when said content does not meet said at least one standard, said new content meeting said at least one standard.

2. The system according to claim 1, said system further comprising an editor interface in communication with said server, wherein said editor interface is usable by a user to edit said new content to thereby produce edited content, said edited content being used to produce said output content.

3. The system according to claim 1, wherein, responsive to instructions from said user, said editor interface generates a content package containing said output content, said content package thereby being useful in said specific field.

4. The system according to claim 2, wherein said editor interface communicates with said analyzer module to iteratively determine whether user content meets said at least one standard, said user content being added in said editor interface by said user.

5. The system according to claim 4, wherein said editor interface further communicates with said transformation module to generate a recommended transformation.

6. The system according to claim 4, wherein, when said user content does not meet said at least one standard, said editor interface displays an alert to said user.

7. The system according to claim 5, wherein, when said user content does not meet said at least one standard, said editor interface displays an alert to said user, and wherein said alert comprises said recommended transformation.

8. The system according to claim 1, wherein said content is text content and said at least one standard relates to at least one of a format used in said field, a language style used in said field, and a grammatical principle.

9. The system according to claim 1, wherein said extraction module is further for pre-processing said content.

10. (canceled)

11. The system according to claim 1, wherein said input source comprises a plurality of input sources, and wherein the transformation module aggregates content from said plurality of input sources, such that said content package generated by said system comprises output content based on said plurality of input sources.

12. A method for generating output content based on other input sources, said generated output content being suitable for a specific use in a specific field, said method comprising the steps of:
receiving an input source;
extracting content from said input source;
determining whether said content meets at least one standard used in said specific field;
when said content does not meet said at least one standard, transforming said content to thereby produce new content, said new content meeting said at least one standard; and
generating a content package comprising said new content.

13. The method according to claim 12, further comprising displaying said new content to a user to thereby permit said user to approve said new content before said content package is generated.

14. The method according to claim 13, wherein said user edits said new content before said content package is generated.

15. The method according to claim 13, further comprising displaying an alert to said user when said content does not meet said at least one standard.

16. The method according to claim 15, wherein said alert comprises a recommended transformation for said content.

17. The method according to claim 13, wherein said alert comprises a current score for said content, said score representing a number of violations of standards currently found in said content.

18. The method according to claim 17, wherein scores for multiple pieces of content are presented to at least one user.

19. The method according to claim 16, wherein said user approves said recommended transformation and wherein said transformation is executed based on said approval by said user.

20. The method according to claim 12, wherein said content is text content and said at least one standard relates to at least one of a format used in said field, a language style used in said field, and a grammatical principle.

21. The method according to claim 12, further comprising a step of pro-processing said content.

22. (canceled)
